(19) United States
(12) Patent Application Publication
(10) Pub. No.: US 2024/0354573 A1
(43) Pub. Date: Oct. 24, 2024

(54) NEURAL NETWORK LEARNING APPARATUS AND METHOD

(71) Applicants: HYUNDAI MOTOR COMPANY, Seoul (KR); KIA CORPORATION, Seoul (KR)

(72) Inventor: Kangil Lee, Incheon (KR)

(73) Assignees: HYUNDAI MOTOR COMPANY, Seoul (KR); KIA CORPORATION, Seoul (KR)

(21) Appl. No.: 18/444,000

(22) Filed: Feb. 16, 2024

(30) Foreign Application Priority Data
Apr. 18, 2023 (KR) 10-2023-0050500

(51) Int. Cl. G06N 3/082; G06N 3/0985

(52) U.S. Cl. CPC G06N 3/082; G06N 3/0985

(57) ABSTRACT

A neural network learning apparatus includes a pruning unit configured to obtain a pruned neural network by pruning on a base neural network. The neural network learning apparatus also includes an optimizing unit configured to obtain an optimized hyperparameter set by performing hyperparameter optimization (HPO) a predetermined number of times using the pruned neural network. The neural network learning apparatus additionally includes a learning unit configured to train the base neural network using the optimized hyperparameter set.

### CROSS-REFERENCE TO RELATED APPLICATION(S)

This application claims the benefit of and priority to Korean Patent Application No. 10-2023-0050500, filed on Apr. 18, 2023, the entire contents of which are incorporated herein by reference.

### TECHNICAL FIELD

The present disclosure relates to a neural network learning apparatus and method.

### BACKGROUND

Generally, deep learning models are highly dependent on hyperparameters. Accordingly, hyperparameter optimization (HPO) is typically performed in developing applications based on deep learning models, even if HPO takes a long time.

As service development using deep learning models becomes more competitive, there is a growing desire for accelerated HPO algorithms and thus improvement of the speed of HPO algorithms is desired.

HPO is time-consuming due to the high computational cost of the deep learning model itself, and it is difficult to find an optimal set of hyperparameters with limited resources.

In some cases, a pruning process is used to reduce the amount of computation in a neural network. Pruning is a process of removing, from the neural network, weights of little importance among many weights learned by the neural network, which may reduce the capacity and the amount of computation required for the inference of the neural network.

Conventionally, processes such as pre-training a neural network, repeatedly pruning the learned neural network with pruning algorithms, and fine-tuning the pruned neural network are performed. Thus it typically takes a lot of time to get a good model.

In addition, the entire layer of the neural network is pruned during pruning, resulting in a layer collapse phenomenon.

### SUMMARY

An aspect of the present disclosure provides a neural network learning apparatus and method configured for performing efficient HPO and neural network learning using the same.

Additional aspects of the disclosure are set forth in part in the description which follows and, in part, should be understood from the description, or may be learned by practice of the disclosure.

In accordance with an embodiment of the present disclosure, a neural network learning apparatus is provided. The neural network learning apparatus includes a pruning unit configured to obtain a pruned neural network by performing pruning on a base neural network. The neural network learning apparatus also includes an optimizing unit configured to obtain an optimized hyperparameter set by performing hyperparameter optimization (HPO) a predetermined number of times using the pruned neural network. The neural network learning apparatus further includes a learning unit configured to train the base neural network using the optimized hyperparameter set.

The base neural network may be a neural network that has not been pre-trained. The pruning unit may be configured to perform pruning on the base neural network by structured single-shot pruning.

The pruning unit may be configured to perform pruning in a channel unit for each layer when performing the pruning on the base neural network.

The pruning unit may be configured to maintain a minimum channel remaining ratio for each layer when performing the pruning in the channel unit.

The pruning unit may be configured to set a pruning ratio and the minimum channel remaining ratio, input a mini-batch only once, calculate gradients according to input values, calculate a score for each weight using the calculated gradients, calculate a score for each channel using the calculated score for each weight, and prune a channel having a score lower than a threshold set based on the pruning ratio.

The pruning unit may be configured to include a first layer as a layer of the pruned neural network when the pruning is performed such that a number of channels remains equal to or greater than the minimum channel remaining ratio with respect to the first layer.

The pruning unit may be configured to include a second layer as a layer of the pruned neural network after additionally assigning a number of channels to the second layer so as to be equal to or greater than the minimum channel remaining ratio when the pruning is performed such that the number of channels remains less than the minimum channel remaining ratio with respect to the second layer.

The pruning unit may be configured to assign, to the second layer, a channel having a higher score among channels pruned in the second layer when additionally assigning the number of channels to the second layer.

The optimizing unit may be configured to perform the HPO using one of random search, evolutionary optimization, or Bayesian optimization.

In accordance with another embodiment of the present disclosure, a neural network learning method is provided. The neural network learning method includes obtaining a pruned neural network by performing pruning on a base neural network. The neural network learning method also includes obtaining an optimized hyperparameter set by performing hyperparameter optimization (HPO) a predetermined number of times using the pruned neural network. The neural network learning method comprises training the base neural network using the optimized hyperparameter set.

The base neural network may be a neural network that has not been pre-trained. Performing pruning on the base neural network may include performing pruning on the base neural network by structured single-shot pruning.

Obtaining the pruned neural network may include, when performing pruning on the base neural network, performing the pruning in a channel unit for each layer.

Obtaining the pruned neural network may include, when performing the pruning in the channel unit, maintaining a minimum channel remaining ratio for each layer.

Obtaining the pruned neural network may include setting a pruning ratio and the minimum channel remaining ratio, inputting a mini-batch only once, calculating gradients according to input values, calculating a score for each weight using the calculated gradients, calculating a score for each channel using the calculated score for each weight, and pruning a channel having a score lower than a threshold set based on the pruning ratio.

Obtaining the pruned neural network may include including a first layer as a layer of the pruned neural network when the pruning is performed such that a number of channels remains equal to or greater than the minimum channel remaining ratio with respect to the first layer.

Obtaining the pruned neural network may further include including a second layer as a layer of the pruned neural network after additionally assigning a number of channels to the second layer so as to be equal to or greater than the minimum channel remaining ratio when the pruning is performed such that the number of channels remains less than the minimum channel remaining ratio with respect to the second layer.

Additionally assigning the number of channels to the second layer may include assigning to the second layer a channel having a higher score among channels pruned in the second layer.

The HPO may use one of random search, evolutionary optimization, or Bayesian optimization.

### BRIEF DESCRIPTION OF THE DRAWINGS

These and/or other aspects of embodiments of the present disclosure should be apparent and more readily appreciated from the following description of the embodiments, taken in conjunction with the accompanying drawings, in which:

FIG. 1 is a block diagram showing components of a neural network learning apparatus, according to an embodiment of the present disclosure;

FIG. 2 shows the pruning processes of the neural network learning apparatus of FIG. 1 as algorithms, according to an embodiment of the present disclosure; and

FIG. 3 is a flowchart illustrating a neural network learning method, according to an embodiment of the present disclosure.

The drawings described herein are for illustration purposes only and are not intended to limit the scope of the present disclosure in any way.

### DETAILED DESCRIPTION

The following description is merely illustrative in nature and is not intended to limit the present disclosure, application, or uses. It should be understood that throughout the drawings, corresponding reference numerals indicate like or corresponding parts and features.

Reference is made below in detail to embodiments of the present disclosure, examples of which are illustrated in the accompanying drawings. This specification does not necessarily describe all elements of the disclosed embodiments. Detailed descriptions of what is well known in the art or redundant descriptions on substantially the same configurations have been omitted. The terms ‘unit’, ‘part’, ‘module’, ‘member’, ‘block’, and the like as used in the specification may be implemented in software or hardware. Further, a plurality of ‘unit’, ‘part’, ‘module’, ‘member’, ‘block’, and the like may be embodied as one component. It is also possible that one ‘unit’, ‘part’, ‘module’, ‘member’, ‘block’, and the like includes a plurality of components.

Throughout the specification, when an element is referred to as being “connected to” another element, it may be directly or indirectly connected to the other element, and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

Throughout the specification, when a member is located “on” another member, this includes not only when one member is in contact with the other member but also when another member is present between the two members.

The terms first, second, and the like are used to distinguish one component from another component, and the component is not limited by these terms.

An expression used in the singular encompasses the expression of the plural unless it has a clearly different meaning in the context.

The reference numerals used in operations are used for descriptive convenience and are not intended to describe the order of operations. The operations may be performed in a different order unless otherwise stated.

When a component, device, element, or the like of the present disclosure is described as having a purpose or performing an operation, function, or the like, the component, device, or element should be considered herein as being “configured to” meet that purpose or to perform that operation or function.

Hereinafter, embodiments of the disclosure are described in detail with reference to the accompanying drawings.

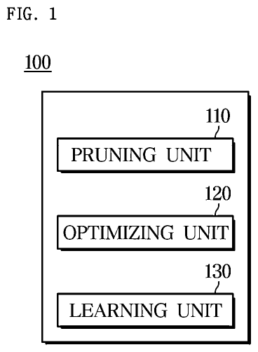

FIG. 1 is a block diagram showing components of a neural network learning apparatus, according to an embodiment of the present disclosure.

Referring to FIG. 1, a neural network learning apparatus 100 according to an embodiment of the present disclosure includes a pruning unit 110 that performs pruning on a base neural network to obtain a pruned neural network. The neural network learning apparatus 100 also includes an optimizing unit 120 that obtains an optimized hyperparameter set by performing hyperparameter optimization (HPO) a predetermined number of times using the pruned neural network. The neural network learning apparatus 100 further includes a learning unit 130 that trains the base neural network using the optimized hyperparameter set.

In an embodiment, the base neural network is a neural network that has not been pre-trained. The pruning unit 110 may perform pruning on the base neural network by structured single-shot pruning.

When pruning the base neural network, the pruning unit 110 may perform a channel unit pruning for each layer.

The pruning unit 110 may maintain a minimum channel remaining ratio for each layer when performing pruning in the channel unit.

In performing pruning on the base neural network, the pruning unit 110 may perform the following operations: setting the pruning ratio and the minimum channel remaining ratio, inputting a mini-batch only once, calculating gradients according to input values, calculating a score for each weight using the calculated gradients, calculating a score for each channel using the calculated score for each weight, and pruning a channel having a score lower than a threshold set based on the pruning ratio.

In an embodiment, when the pruning is performed such that the number of channels remains equal to or greater than the minimum channel remaining ratio with respect to a first layer, the pruning unit 110 may include the first layer as a layer of the pruned neural network.

Furthermore, when the pruning is performed such that the number of channels remains less than the minimum channel remaining ratio with respect to a second layer, the pruning unit 110 may additionally assign the number of channels to the second layer so as to be equal to or greater than the minimum channel remaining ratio. The pruning unit 110 may then include the second layer as a layer of the pruned neural network.

In assigning the number of channels to the second layer, the pruning unit 110 may assign a channel having a higher score among the channels pruned in the second layer to the second layer.

The optimizing unit 120 may obtain an optimized hyperparameter set by performing the HPO a predetermined number of times using the pruned neural network. The optimizing unit 120 may perform the HPO using any one of random search, evolutionary optimization, or Bayesian optimization.

The learning unit 130 may obtain an optimal neural network by training the base neural network using the hyperparameter set obtained by the optimizing unit 120.

The neural network learning apparatus 100 may include a control unit (not shown) that controls each of the above-described components and means associated therewith. The control unit may include various processors and memories (not shown). The memory may store programs, instructions, applications, and the like for performing the control. Each processor may execute programs, instructions, applications, etc. stored in the memory.

The memory may include, for example, a nonvolatile memory device, such as a cache, read only memory (ROM), programmable ROM (PROM), erasable programmable ROM (EPROM), electrically erasable programmable ROM (EEPROM), and flash memory. Additionally or alternatively, the memory may include a volatile memory device, such as random access memory (RAM), and may include a storage medium, such as hard disk drive (HDD) and CD-ROM. Such a memory may store various algorithms, setting values, data, etc. required for a neural network training process according to embodiments of the present disclosure.

Hereinafter, components of the neural network learning apparatus 100, according to embodiments, are described in detail.

The pruning unit 110 performs pruning on the base neural network to obtain a pruned neural network. Conventional pruning methods generally include the process of pre-training a neural network, repeatedly performing pruning on the learned neural network according to pruning algorithms, and fine-tuning the pruned neural network. In an embodiment of the present disclosure, pruning may be performed on a base neural network that has not been pre-trained. For example, pruning of the base neural network may be performed by structured single-shot pruning. The base neural network represents a general neural network without pre-training.

Because a single-shot pruning method inputs a mini-batch only once, the cost required for pruning is very low compared to a typical pruning method in which mini-batches are input repeatedly.

Furthermore, in an embodiment of the present disclosure, pruning may be performed in units of channels for each layer in order to perform pruning on a base neural network by structured single-shot pruning.

When pruning is performed in a channel unit, a layer collapse may be prevented by maintaining a minimum channel remaining ratio for each layer.

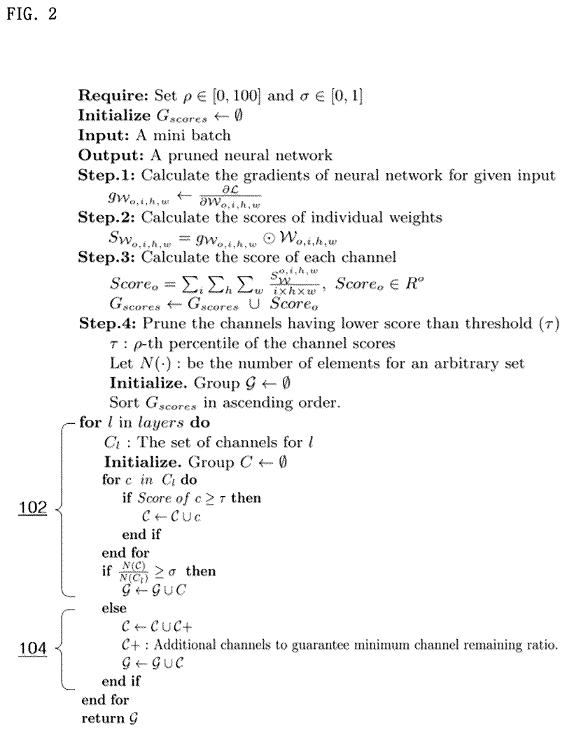

A pruning processes according to an embodiment of the present disclosure is described in detail based on the algorithms shown in FIG. 2.

FIG. 2 shows pruning processes of the neural network learning apparatus of FIG. 1 as an algorithm, according to an embodiment of the present disclosure.

Referring to FIG. 2, in performing pruning on the base neural network, the pruning ratio and the minimum channel remaining ratio are first set as described in a require part.

A global score set (G_{scores}) is initialized to 0 (i.e., zero).

A mini-batch is then input only once.

In Step 1, gradients are calculated according to the mini-batch input values. When a backward operation is performed after a loss is calculated in a forward pass, the gradient of each weight for the loss may be calculated by a chain rule. The gradient

$$( \frac{\partial L}{{W}_{o , i , h , w}} )$$

may be calculated from the differentiation of the loss function (L) and the weight (W), and the calculated gradient is updated to gw_{o,i,h,w} Herein, o,i,h,w denote the dimension of an output channel, the dimension of an input channel, a height, and a width, respectively.

In Step 2, the scores of the individual weights are calculated using the calculated gradients. The score for each weight may be calculated using the above-described calculation between the gradient and the weight.

For example, the score calculation formula for each weight in convolution may be expressed as Equation 1 below.

$${S}_{W}^{o , i , h , w} = \vert \frac{\partial L ( x )}{\partial {W}_{o , i , h , w}} ⊙ {W}_{o , i , h , w \}} \vert \qquad Equation 1$$

In Equation 1, x denotes an input value and W_{o,i,h,w} denotes a weight of a second-dimensional (2D) convolution filter. In addition, the sum of Logits is used as a loss function L.

In Step 3, the score for each channel is calculated using the calculated score for each weight. The calculated score for each channel is updated to a global score set (G_{scores}).

For example, the score calculation formula for each channel in convolution may be expressed as Equation 2 below.

$${Score}_{o} = {\sum }_{i} {\sum }_{h} {\sum }_{w} \frac{{s}_{W}^{o , i , h , w}}{i \times h \times w} , \qquad Equation 2$$

$${Score}_{o} ∈ {R}^{o}$$

To obtain a score suitable for structured pruning in units of channels in Equation 2, an average value of importance is calculated based on a fan-out axis (also referred to as an output channel).

In Step 4, the channels having lower scores than a threshold set based on the pruning ratio are pruned. For example, when the pruning ratio is 95%, the channels having scores lower than the top 5% scores based on the threshold are pruned. In this case, after sorting on a global score set in ascending order, pruning may be performed on the channels having scores lower than the threshold.

A portion 102 may be performed to implement a process of updating a temporary channel set C by channels having scores equal to or greater than the threshold, and pruning such that, for example, the number of channels remains equal to or greater than the minimum channel remaining ratio σ with respect to the temporary channel set C of the first layer. In this case, the first layer may be included as a layer of the pruned neural network.

A portion 104 may be performed, for example, when pruning is performed such that the number of channels remains less than the minimum channel remaining ratio with respect to the temporary channel set C of the second layer. In this case, the process of additionally assigning the number of channels to the second layer in order to be equal to or greater than the minimum channel remaining ratio may be performed.

In additionally allocating the number of channels to the second layer, a channel having a higher score among the channels pruned in the second layer may be assigned to the second layer.

Accordingly, if the second layer has a number of channels equal to or greater than the minimum channel remaining ratio, the second layer may be included as a layer of the pruned neural network.

In an embodiment, the optimizing unit 120 may obtain an optimized hyperparameter set by performing the HPO a predetermined number of times using the pruned neural network, and perform the HPO using any one of random search, evolutionary optimization, and Bayesian optimization.

The random search may perform random sampling on a probability distribution of hyperparameters until a predetermined budget is exhausted or a desired performance is achieved.

The Evolutionary optimization may consider multiple sets of hyperparameters sampled from a probability distribution as one generation, leaving only the robust set of hyperparameters among the multiple sets. Then, the process of updating the parameters of the probability distribution using the remaining set may be performed iteratively, aiming to find the optimal probability distribution.

The Bayesian optimization may estimate a probability distribution of an objective function and finds the most promising hyperparameters from the estimated distribution. The Gaussian process in Bayesian optimization may be used as a probabilistic surrogate model because it requires a large amount of computation to directly estimate the probability distribution of the objective function.

TABLE 1

| | | | Accuracy(%) | | |
|---|---|---|---|---|---|
| | Hyperparameter | Neural | Typical | With | Time |
| Dataset | Optimizer | Network | HPO | Pruning | Reduction |
| CIFAR10 | TYPE | ResNet56 | 93.43 ± 0.23 | 93.62 ± 0.32 | 12% |
| | | VGG16-BN | 93.41 ± 0.42 | 93.61 ± 0.07 | 23% |
| | | MobileNetV2 | 94.54 ± 0.14 | 94.87 ± 0.36 | 32% |
| | BO | ResNet56 | 93.04 ± 0.37 | 93.18 ± 0.58 | 12% |
| | | VGG16-BN | 93.70 ± 0.14 | 93.94 ± 0.22 | 23% |
| | | MobileNetV2 | 94.58 ± 0.42 | 95.27 ± 0.10 | 32% |
| | CMA-ES | ResNet56 | 93.11 ± 0.39 | 93.50 ± 0.20 | 12% |
| | | VGG16-BN | 93.30 ± 0.36 | 93.79 ± 0.21 | 23% |
| | | MobileNetV2 | 94.66 ± 0.65 | 95.40 ± 0.10 | 32% |
| CIFAR100 | TYPE | ResNet56 | 71.24 ± 0.23 | 72.31 ± 0.73 | 12% |
| | | VGG16-BN | 73.51 ± 0.34 | 73.36 ± 0.47 | 22% |
| | | MobileNetV2 | 77.84 ± 2.22 | 77.89 ± 1.47 | 37% |
| | BO | ResNet56 | 71.23 ± 1.19 | 71.74 ± 1.59 | 12% |
| | | VGG16-BN | 73.00 ± 0.60 | 73.43 ± 0.34 | 22% |
| | | MobileNetV2 | 76.20 ± 1.66 | 78.57 ± 0.72 | 37% |
| | CMA-ES | ResNet56 | 71.32 ± 0.54 | 71.05 ± 0.45 | 12% |
| | | VGG16-BN | 72.25 ± 0.42 | 73.47 ± 0.30 | 22% |
| | | MobileNetV2 | 74.78 ± 1.52 | 75.90 ± 1.03 | 37% |
| TinyImageNet | TYPE | ResNet56 | 52.92 ± 0.80 | 52.29 ± 0.94 | 20% |
| | | VGG16-BN | 61.49 ± 0.55 | 61.03 ± 0.44 | 16% |
| | | MobileNetV2 | 57.99 ± 0.44 | 56.99 ± 1.40 | 23% |
| | BO | ResNet56 | 51.72 ± 0.36 | 51.34 ± 0.76 | 20% |
| | | VGG16-BN | 56.48 ± 2.25 | 58.44 ± 1.96 | 16% |
| | | MobileNetV2 | 57.84 ± 0.42 | 56.08 ± 1.45 | 23% |
| | CMA-ES | ResNet56 | 52.96 ± 0.70 | 52.60 ± 0.30 | 20% |
| | | VGG16-BN | 56.27 ± 2.27 | 58.78 ± 2.01 | 16% |
| | | MobileNetV2 | 57.87 ± 1.72 | 56.32 ± 1.82 | 23% |

In Table 1, time reduction represents the average percentage reduction from a forward pass to a backward pass for the same batch size, and the higher the percentage % is the better.

To verify that the HPO framework is valid for all HPO methods, an experiment was conducted in which representative ways of the three HPO methods described above (i.e., random search, evolutionary optimization, and Bayesian optimization) were employed respectively. As a result, as can be seen from the time reduction in Table 1, the time required can be reduced by up to 37%, and the performance is almost the same as that of general HPO.

Therefore, it can be seen that the use of the pruned neural network according to an exemplary embodiment of the present disclosure reduces the time required for the HPO, in at least some embodiments.

The learning unit 130 may obtain an optimal neural network by training the base neural network using the hyperparameter set obtained by the optimizing unit 120.

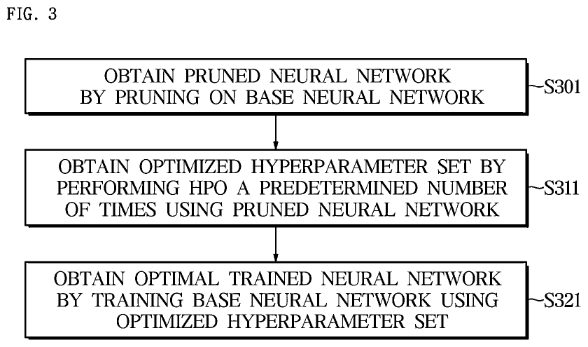

FIG. 3 is a flowchart illustrating a neural network learning method, according to an embodiment. In an embodiment, the neural network learning method may be performed using the neural network learning apparatus of FIG. 1.

In an operation S301, the pruned neural network is obtained by pruning on the base neural network.

The base neural network may be a neural network in which pre-training is not performed. The pruning unit 110 may perform pruning on the base neural network by structured single-shot pruning.

When performing the pruning of the base neural network in the operation S301, pruning may be performed in units of channels for each layer.

In an embodiment, when pruning is performed in units of channels, the minimum channel remaining ratio is maintained for each layer.

The operation S301 may include the processes of setting the pruning ratio and the minimum channel remaining ratio, inputting the mini-batch only once, calculating gradients according to the input values, calculating the score for each weight using the calculated gradients, calculating the score for each channel using the calculated score for each weight, and pruning the channel having a score lower than the threshold set based on the pruning ratio.

When the pruning is performed such that the number of channels remains equal to or greater than the minimum channel remaining ratio with respect to the first layer, the first layer may be included as a layer of the pruned neural network.

Furthermore, when the pruning is performed such that the number of channels remains less than the minimum channel remaining ratio with respect to the second layer, the number of channels is additionally assigned to the second layer so as to be equal to or greater than the minimum channel remaining ratio and thus the second layer may be included as a layer of the pruned neural network.

The process of additionally assigning the number of channels to the second layer may include assigning a channel having a higher score among channels pruned in the second layer to the second layer.

In an operation S311, the optimized hyperparameter set is obtained by performing the HPO a predetermined number of times using the pruned neural network.

The HPO process may use any one of the random search, the evolutionary optimization, or the Bayesian optimization.

In an operation S321, the optimal trained neural network is obtained by training the base neural network using the optimized hyperparameter set.

As should be apparent from the above, the neural network learning apparatus and method can perform efficient HPO and neural network learning using the same.

Furthermore, the advantages of the present disclosure are not limited to those mentioned above, and other advantages not mentioned should be clearly understood by a person having ordinary skill in the art from the scope of the claims.

The above-described embodiments may be implemented in the form of a recording medium storing instructions executable by a computer. The instructions may be stored in the form of program code. When the instructions are executed by a processor, a program module is generated by the instructions so that the operations of the disclosed embodiments may be carried out. The recording medium may be implemented as a non-transitory computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although embodiments of the present disclosure have been shown and described, it would be appreciated by those having ordinary skill in the art that changes may be made in these embodiments without departing from the principles and spirit of the present disclosure, the scope of which is defined in the claims and their equivalents.

What is claimed is:

1. A neural network learning apparatus, comprising:
a pruning unit configured to obtain a pruned neural network by performing pruning on a base neural network;
an optimizing unit configured to obtain an optimized hyperparameter set by performing hyperparameter optimization (HPO) a predetermined number of times using the pruned neural network; and
a learning unit configured to train the base neural network using the optimized hyperparameter set.

2. The neural network learning apparatus of claim 1, wherein:
the base neural network is a neural network that has not been pre-trained, and
the pruning unit is configured to perform pruning on the base neural network by structured single-shot pruning.

3. The neural network learning apparatus of claim 1, wherein the pruning unit is configured to, when performing the pruning on the base neural network, perform the pruning in a channel unit for each layer.

4. The neural network learning apparatus of claim 3, wherein the pruning unit is configured to, when performing the pruning in the channel unit, maintain a minimum channel remaining ratio for each layer.

5. The neural network learning apparatus of claim 4, wherein the pruning unit is configured to:
set a pruning ratio and the minimum channel remaining ratio,
input a mini-batch only once,
calculate gradients according to input values,
calculate a score for each weight using the calculated gradients,
calculate a score for each channel using the calculated score for each weight, and
prune a channel having a score lower than a threshold set based on the pruning ratio.

6. The neural network learning apparatus of claim 5, wherein the pruning unit is configured to include a first layer as a layer of the pruned neural network when the pruning is performed such that a number of channels remains equal to or greater than the minimum channel remaining ratio with respect to the first layer.

7. The neural network learning apparatus of claim 5, wherein the pruning unit is configured to include a second layer as a layer of the pruned neural network after additionally assigning a number of channels to the second layer so as to be equal to or greater than the minimum channel remaining ratio when the pruning is performed such that the number of channels remains less than the minimum channel remaining ratio with respect to the second layer.

8. The neural network learning apparatus of claim 7, wherein the pruning unit is configured to, when additionally assigning the number of channels to the second layer, assign, to the second layer, a channel having a higher score among channels pruned in the second layer.

9. The neural network learning apparatus of claim 1, wherein the optimizing unit is configured to perform the HPO using one of random search, evolutionary optimization, or Bayesian optimization.

10. A neural network learning method, comprising:
obtaining a pruned neural network by performing pruning on a base neural network;
obtaining an optimized hyperparameter set by performing hyperparameter optimization (HPO) a predetermined number of times using the pruned neural network; and
training the base neural network using the optimized hyperparameter set.

11. The neural network learning method of claim 10, wherein:
the base neural network is a neural network that has not been pre-trained, and
performing pruning on the base neural network comprises performing pruning on the base neural network by structured single-shot pruning.

12. The neural network learning method of claim 10, wherein obtaining the pruned neural network includes, when performing pruning on the base neural network, performing the pruning in a channel unit for each layer.

13. The neural network learning method of claim 12, wherein obtaining the pruned neural network includes, when performing the pruning in the channel unit, maintaining a minimum channel remaining ratio for each layer.

14. The neural network learning method of claim 13, wherein obtaining the pruned neural network includes:
setting a pruning ratio and the minimum channel remaining ratio,
inputting a mini-batch only once,
calculating gradients according to input values,
calculating a score for each weight using the calculated gradients,
calculating a score for each channel using the calculated score for each weight, and
pruning a channel having a score lower than a threshold set based on the pruning ratio.

15. The neural network learning method of claim 14, wherein obtaining the pruned neural network includes including a first layer as a layer of the pruned neural network when the pruning is performed such that a number of channels remains equal to or greater than the minimum channel remaining ratio with respect to the first layer.

16. The neural network learning method of claim 14, wherein obtaining the pruned neural network includes including a second layer as a layer of the pruned neural network after additionally assigning a number of channels to the second layer so as to be equal to or greater than the minimum channel remaining ratio when the pruning is performed such that the number of channels remains less than the minimum channel remaining ratio with respect to the second layer.

17. The neural network learning method of claim 16, wherein additionally assigning the number of channels to the second layer includes assigning, to the second layer, a channel having a higher score among channels pruned in the second layer.

18. The neural network learning method of claim 10, wherein the HPO uses one of random search, evolutionary optimization, or Bayesian optimization.
